(19) United States
(12) Patent Application Publication
(10) Pub. No.: US 2004/0135812 A1
(43) Pub. Date: Jul. 15, 2004

(54) Method of establishing a re-configurable taskbar

(75) Inventors: Lu-Yun Tai, Taoyuan (TW); Hung-Ming Chen, Taipei (TW)

Correspondence Address: BACON & THOMAS, PLLC, 625 SLATERS LANE, FOURTH FLOOR, ALEXANDRIA, VA, 22314

(73) Assignee: Tatung Co., Ltd., Taipei (TW)

(21) Appl. No.: 10/400,628

(22) Filed: Mar. 28, 2003

(30) Foreign Application Priority Data
Jan. 10, 2003 (TW) 92100498

(51) Int. Cl. G09G 5/00

(52) U.S. Cl. 345/779

(57) ABSTRACT

An information device has an operating system used for establishing a re-configurable taskbar on a display, the taskbar capable of reading from a default taskbar file or a custom taskbar file. The default taskbar file is stored in a folder pointed to by a default path and defined as having a plurality of default options displayable in the taskbar. The custom taskbar file is stored in a folder pointed to by a specific path and defined as having the aforementioned default component and a custom component storing customization settings for at least one user. The custom taskbar file has a corresponding registration code. When the information apparatus receives a command for generating the taskbar and detects that the registration code is valid, it will read the custom taskbar file and displays the taskbar on the display according to the custom taskbar file.

### BACKGROUND OF THE INVENTION

1. Field of the Invention

The present invention relates to a method of establishing a taskbar, and more particularly to a method of establishing a re-configurable taskbar in an information apparatus having a windowing system taskbar.

2. Description of the Related Art

Within a desktop displayed on a typical information apparatus, a row of option menus located at the bottom (or top, left, right) of a display window is called a taskbar (or a toolbar). The taskbar is used for displaying a system tray area, a start menu, an active window icon, etc. The system tray area displays various system tray icons, which may relate to a printing device, volume control, an input means, network status, time and date settings, or various external programs. A user may click on these icons to execute a corresponding function.

However, the taskbar displayed in the prior art information apparatus provides only an automatic hiding/displaying function for the user, and presentation mode of the taskbar is inflexible. The user can only place the taskbar in a horizontal direction (along the top or the bottom of the window) or in a vertical direction (along the left side or the right side of the window). The prior art information apparatus has some applications that can provide custom taskbar functionality, but these applications only provide control of the displaying and hiding of defined items. In these prior art applications, in order to provide individualized requirements for a taskbar, the taskbar program must be redesigned to change the visual characteristics, position, size, and displaying status of the taskbar, which is not ideal.

Therefore, it is desirable to provide an improved taskbar to mitigate and/or obviate the aforementioned problems.

### SUMMARY OF THE INVENTION

A main objective of the present invention is to provide a method of establishing a re-configurable taskbar in an information apparatus, which enables the information apparatus to display the taskbar on the window according to XML file settings, and changes the visual characteristics and the related properties of the taskbar by appropriate modification to the XML file to increase application flexibility and diversity.

Another objective of the present invention is to provide a method of establishing a re-configurable taskbar in an information apparatus that can determine when to display or hide various taskbar items to display a customized taskbar.

In order to achieve the above-mentioned objectives, the present invention provides a method of establishing a re-configurable taskbar in an information apparatus. The information apparatus has an operating system for generating the taskbar on a display, and the taskbar reads from a file selected from the group of a default taskbar file and a custom taskbar file. The default taskbar file is stored in a folder pointed to by a default path and defined as having a plurality of default options selected for displaying in the taskbar. The custom taskbar file is stored in a folder pointed to by a specific path and defined as having a default component storing the plurality of default options, and a custom component storing customization settings of the plurality of default options for at least one user. The custom taskbar file has a corresponding registration code.

The present invention method involves receiving a command for generating the taskbar; detecting if the registration code is valid; reading the custom taskbar file from the folder pointed by the specific path if the registration code is valid; and displaying the taskbar on the display according to the custom taskbar file.

The present invention can be implemented by way of a software program, and the present invention can be written in an appropriate computer language to be loaded onto a computer readable medium. The medium can be an IC chip, a hard disk, an optical disk or any other software recording medium, but random access memory is considered a better choice as it is easy to update.

Other objects, advantages, and novel features of the invention will become more apparent from the following detailed description when taken in conjunction with the accompanying drawings.

### BRIEF DESCRIPTION OF THE DRAWINGS

FIG. 1 is a functional block drawing of a custom taskbar file in an embodiment according to the present invention.

FIG. 2 is a flowchart of the embodiment according to the present invention.

FIG. 3 is a schematic drawing of the taskbar in the embodiment according to the present invention.

### DETAILED DESCRIPTION OF THE PREFERRED EMBODIMENT

An embodiment of the present invention may be applied in an information apparatus, and the information apparatus has a display, such as a computer monitor, a mobile phone screen, a PDA (personal digital assistant), or a touch screen, for displaying a taskbar (also called toolbar) generated by a windowing system. The information apparatus of the preferred embodiment is a WebPAD, and uses the Windows CE.NET operating system, as well as a related explorer.exe application program of the Windows CE.NET operation system can interpret and execute a command from a user to the operating system to display a taskbar on the display of the information apparatus.

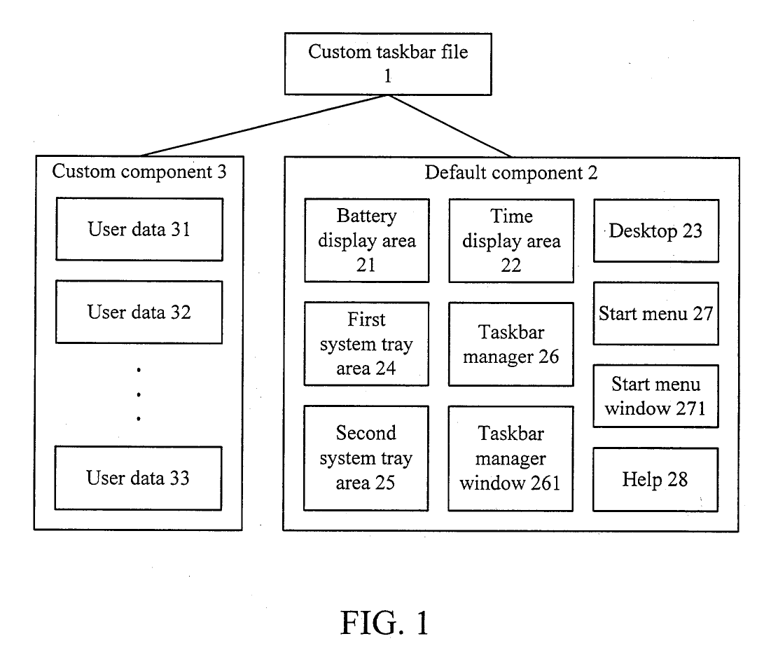

The taskbar in this embodiment reads file data from a default taskbar file or a custom taskbar file, both of which are encoded in the extensible markup language (XML) file format. The default taskbar file is stored in a folder pointed to by a default path and is a read-only file set by the windowing system. The default taskbar file is defined as having a plurality of default options displayable in the taskbar. When the user wants to modify data in the default taskbar file, he or she needs to establish a custom taskbar having a filename that is identical to the filename of the default taskbar file. The custom taskbar file is stored in a folder pointed to by a specific path, and may be stored in a hard disk or other storage device. Please refer to FIG. 1. FIG. 1 is a functional block drawing of a custom taskbar file in an embodiment according to the present invention. The custom taskbar file 1 of this embodiment is defined as having a default component 2 and a custom component 3, and program code coded in the XML language in a manner similar to the following:

Default Component 2:

<Taskbar>

align=

height=

bgImageX1=

bgImageY1=

bgImageW1=

bgImageH1=

bgImage1=

</Taskbar>

<Battery display area>

x=

width=

height=

bgImage1=

show=

</Battery display area>

<Time display area>

x=

y=

width=

height=

bgImage1=

show=

</Time display area>

. . .

Custom Component 3:

<User data 1>

x=

y=

width=

height=

bgImage1=

bgImage2=

apName=

</User data 1>

<User data 2>

x=

y=

width=

height=

bgImage1=

bgImage2=

apName=

</User data 2>

. . .

As shown in FIG. 1, the default component 2 stores default options defined by the default taskbar file, which includes options such as a battery display area 21, a time display area 22, a desktop 23, a first system tray area 24, a second system tray area 25, a taskbar manager 26, a taskbar manager window 261, start menu 27, a start menu window 271, and help 28. The file stored in the default component 2 is a taskbar style predetermined by the windowing system, and the difference between the default component 2 of the custom taskbar file 1 and the default taskbar file is the default taskbar file is that of being read-only. The default component 2 allows the user to modify all configurations of the default options on the taskbar to improve the diversity of use. The user can also add other options by supplying them in the custom component 3, and uses “apName” in the XML file to indicate an application program for initiating and generating user data 31, user data 32 and user data 33 for different users. The custom taskbar file 1 has a corresponding registration code for determining whether the default taskbar file or the custom taskbar file 1 is used to generate the taskbar.

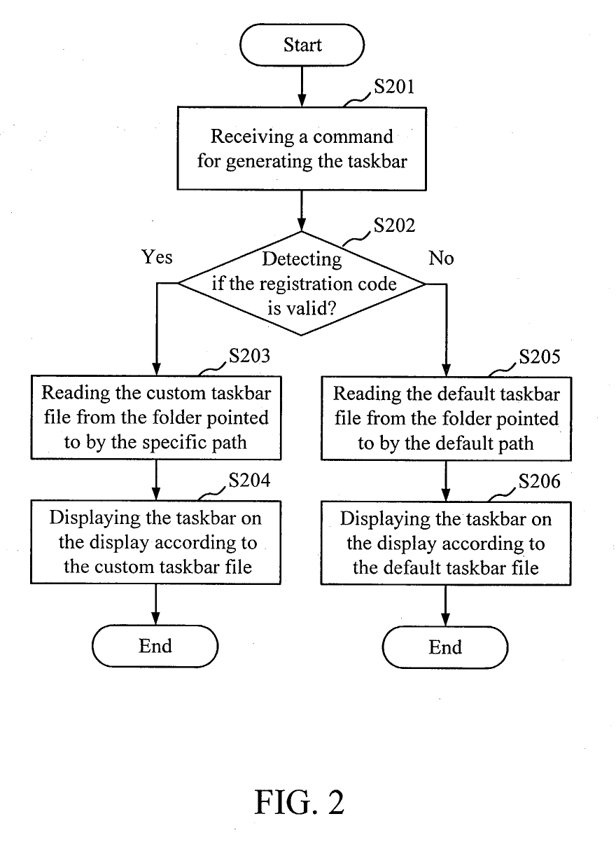

Please refer to FIG. 2. FIG. 2 is a flowchart of an embodiment according to the present invention. The information apparatus receives a command for generating the taskbar (step S201) and detecting if the registration code is valid (step S202). If the registration code is valid, the information apparatus reads the custom taskbar file 1 from the folder pointed to by the specific path (step S203) and displays the taskbar on the display according to the custom taskbar file 1 (step S204).

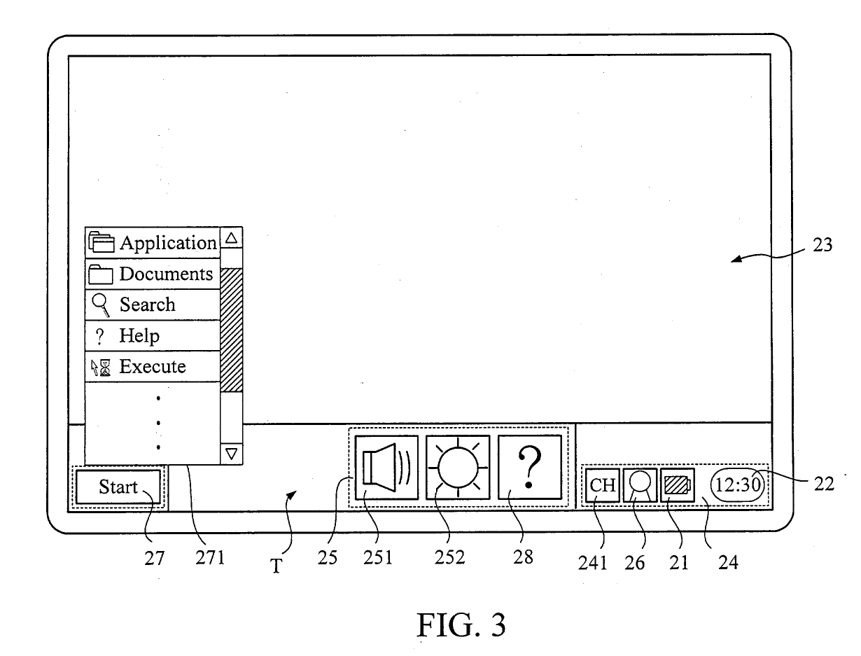

In this embodiment, the default component 2 of the custom taskbar file 1 displays a taskbar T according to the user data 31 as shown in FIG. 3. The battery display area 21, the time display area 22 and the taskbar manager 26 are defined in the first system tray area 24, which is used for displaying small icons (which are typically 16×16 pixels in size) and displays a switching input method 241 according to a new component added by the user data 31. The second system tray area 25, which is used for displaying large icons (typically 32×32 pixels in size), has the help option 28, a volume adjusting icon 251 and a light adjusting icon 252, which may be clicked upon by the user. Moreover, the desktop 23, the start menu 27 and the start menu window 271 are generated on the display according to the default component 2 and the user data 31. In additional, the default options can be set as hidden. For example, the taskbar manager window 261 is shown in the taskbar.

When the registration code is invalid, the information apparatus reads the default taskbar file from the folder pointed to by the default path (step S205) and displays the taskbar on the display according to the default taskbar file (step S206).

According to the above-mentioned description, the present invention displays the taskbar according to XML format files, and so the user can change the taskbar display style by modifying the XML file. Furthermore, the user not only can change each icon property on the taskbar, but can also determine the displayed position of the taskbar on the display.

The above-mentioned steps can be written as a software program in any suitable computer language, and be compiled or assembled for execution. The software program can be stored on any recording media that can be recognized and decoded by a processing unit, or any product comprising such a recording media. The recording media can be a hard disk, a floppy disk, an optical disk, a ZIP disk, an MO, an IC chip, RAM, or any other known product. As all of the detailed steps are completely described, there is no need for further explanation.

The invention has been described using exemplary preferred embodiments. However, for those skilled in this field the preferred embodiments can be easily adapted and modified to suit additional applications without departing from the spirit and scope of this invention. Thus, it is to be understood that the scope of the invention is not limited to the disclosed embodiments. On the contrary, it is intended to cover various modifications and similar arrangements based upon the same operating principle. The scope of the claims, therefore, should be accorded the broadest interpretations so as to encompass all such modifications and similar arrangements.

Although the present invention has been explained in relation to its preferred embodiment, it is to be understood that many other possible modifications and variations can be made without departing from the spirit and scope of the invention as hereinafter claimed.

What is claimed is:

1. A method of establishing a re-configurable taskbar in an information apparatus, the information apparatus having an operating system used for generating the taskbar on a display, the taskbar capable of reading from a file selected from the group of a default taskbar file and a custom taskbar file, wherein the default taskbar file is stored in a folder pointed to by a default path and defined as having a plurality of default options selected for displaying in the taskbar; the custom taskbar file stored in a folder pointed to by a specific path and defined as having a default component storing the plurality of default options and a custom component storing customization settings of the plurality of default options for at least one user, the custom taskbar file having a corresponding registration code, the method comprising:
(A) receiving a command for generating the taskbar;
(B) detecting if the registration code is valid; if so proceeding to step (C);
(C) reading the custom taskbar file from the folder pointed to by the specific path; and
(D) displaying the taskbar on the display according to the custom taskbar file.

2. The method as claimed in claim 1, wherein in step (B), if the registration code is invalid, then proceeding to the following steps:
(C′) reading the default taskbar file from the folder pointed to by the default path; and
(D′) displaying the taskbar on the display according to the default taskbar file.

3. The method as claimed in claim 1, wherein the custom component stores at least one item of user data, and each item of user data is used as customization settings data of the plurality of default options for one user.

4. The method as claimed in claim 3, wherein in step (D), the current related user data is obtained from the custom component of the custom taskbar file to display a customized taskbar on the display.

5. The method as claimed in claim 1, wherein the default taskbar file and the custom taskbar file are extensible markup language (XML) format files.

6. The method as claimed in claim 1, wherein a filename of the custom taskbar file is identical to a filename of the default taskbar file.

7. The method as claimed in claim 1, wherein the default taskbar file is a read-only file.

8. A computer readable memory media storing a software program for use in an information device, the information device having an operating system used for generating a taskbar on a display, the taskbar capable of reading from a file selected from the group of a default taskbar file and a custom taskbar file, wherein the default taskbar file is stored in a folder pointed to by a default path and defined as having a plurality of default options selected for displaying in the taskbar; the custom taskbar file stored in a folder pointed to by a specific path and defined as having a default component storing the plurality of default options and a custom component storing customization settings of the plurality of default options for at least one user, the custom taskbar file having a corresponding registration code, the software program comprising:
a first program code for receiving a command for generating the taskbar;
a second program code for detecting if the registration code is valid;
a third program code for reading the custom taskbar file from the folder pointed to by the specific path in response to a detection performed in the second program code; and
a fourth program code, for displaying the taskbar on the display according to the custom taskbar file.

9. The readable memory media as claimed in claim 8, wherein in the second program code further comprises:
a third (A) program code for reading the default taskbar file from the folder pointed to by the default path; and
a fourth (A) program code for displaying the taskbar on the display according to the default taskbar file;
wherein the third (A) and the fourth (A) program codes are executed if the registration code is invalid.

10. The readable memory media as claimed in claim 8, wherein the custom component stores at least one item of user data, and each item of user data is used as customization settings data of the plurality of default options for one user.

11. The readable memory media as claimed in claim 10, wherein in the fourth program code, the current related user data is obtained from the custom component of the custom taskbar file to display a customized taskbar on the display.
